(19) United States
(12) Patent Application Publication
(10) Pub. No.: US 2026/0073244 A1
(43) Pub. Date: Mar. 12, 2026

(54) SYSTEMS AND METHODS FOR FEDERATED KNOWLEDGE GOVERANCE

(71) Applicant: CVS Pharmacy, Inc., Woonsocket, RI (US)

(72) Inventor: Victor A. Danilchenko, Woonsocket, RI (US)

(21) Appl. No.: 18/827,114

(22) Filed: Sep. 6, 2024

(51) Int. Cl. G06N 5/022; G06F 16/93

(52) U.S. Cl. CPC G06N 5/022; G06F 16/93

(57) ABSTRACT

In some instances, a method is provided. The method comprises: receiving, from a consumer device and by a federated knowledge base (KB) computing platform, a search request for a certified version of a first document that is stored in a first KB computing system; based on the search request, determining, by the federated KB computing platform, a first document snapshot reference that comprises an identifier that identifies a storage location of the certified version of the first document within the first KB computing system; retrieving, by the federated KB computing platform and based on the determination, the identifier that identifies the storage location of the certified version of the first document within the first KB computing system; and using the identifier to access the certified version of the first document that is stored in the first KB computing system.

### BACKGROUND

Knowledge management (KM) may be a process of organizing, creating, using, and/or sharing collective knowledge within the enterprise organization, and successful KM includes maintaining information in a place where it is easy to access such as an employee intranet. For enterprise organizations, KM may become an especially important practice, and the larger the enterprise organization, the more crucial KM becomes. Typically, the KM practice may be carried out using knowledge bases (KB) (e.g., a central repository that stores knowledge documents such as travel policies for the enterprise organization). For example, multiple entities (e.g., authors, publishers, and/or subject matter experts (SMEs)) may author, publish, and/or certify documents that are stored within KBs.

However, centralization of the KBs may be difficult to implement, particularly in large enterprises with inconsistent organizational practices and cultural norms across organizational units. For example, a human resource (HR) department may store travel and/or work policies for the enterprise organization and an information technology (IT) department may store security policies for the enterprise organization. But, the HR and IT departments may have different organizational practices and/or cultural norms. A typical solution to the problem of heterogeneity is to either centralize the KM practice, use a single central KB, or to federate the KB, which allows the KB to present various knowledge sources in the same discovery and consumption context. The federation approach is powerful due to being flexible and presenting a low barrier to entry, but it has a critical problem: it is very difficult to impose governance over federated KB's participating systems. Accordingly, there remains a technical need to perform federated knowledge governance for enterprise organizations, especially large enterprise organizations.

### SUMMARY

In some examples, the present application provides a method and system for performing federated knowledge governance for enterprise organizations. For example, an enterprise organization may provide a plurality of different services to individuals (e.g., consumers) such as a grocery pick-up service, a prescription pick-up service, an insurance service, a streaming service, and/or other services. The enterprise organization may prepare documents (e.g., policy documents, WORD documents, Markdown (md) files, VISIO diagram files, and/or other types of static documentation files) to carry out the services provided by the organization. For example, the HR department for the enterprise organization may share one or more policies such as travel policies, vacation policies, and so on. Further, the IT department may share other policies such as network security policies for the enterprise organization. These departments may prepare data including md files to describe the project (e.g., documents describing the application programming interfaces (APIs) and/or software applications that the department is currently working on). Each of these documents (e.g., the policies (e.g., WORD documents), md files, and/or other types of documents/data that may be generated by the enterprise organization to serve their customers) may be stored within its own knowledge base (KB) such as a repository and/or database. To access each of these documents that are stored within different KBs, a federated KB system may be used. However, as mentioned above, it may become difficult to impose governance over the federated KB system's participating KBs (e.g., the KBs associated with the different departments). For instance, authors for each of the different departments may revise and/or change certain documents and store the latest version of the documents within their own KBs. But, these latest versions may require further review and analysis prior to certifying and implementing the documents. For example, an author may provide an update to the vacation policy and store the updated policy (e.g., an updated vacation policy document) into the HR KB. However, this update might not be certified by an SME. Traditionally, when a consumer seeks to obtain a particular document (e.g., the vacation policy), a federated computing system may seek to obtain the latest version of the document. But, as indicated in the example above, this latest document might not be the certified version (e.g., the version that is currently being implemented by the enterprise organization).

As such, the present application provides a method and system that allows a consumer to access the certified version of the document based on the snapshot reference, which identifies a storage location of the certified version of the document within the KB. For example, the KB (e.g., the HR KB) may store multiple versions of a policy document (e.g., vacation policy document). One of the versions, which may or may not be the latest version of the document, may be the certified version of the document. Instead of storing the certified version of the document, the federated KB computing platform may store snapshot references (e.g., links or deep links) indicating certified versions of documents that are tracked within the KBs. Additionally, and/or alternatively, the federated KB computing platform may further store snapshot references of uncertified versions of the documents (e.g., the latest version of the travel policy document that has been updated by an author, but not certified). Then, a consumer, using a consumer device, may seek to obtain the certified version of the document (e.g., the certified version of the policy document). The federated KB computing platform may determine the snapshot reference associated with the certified version of the document, and the snapshot reference may comprise an identifier such as a link and/or deep link that indicates the storage location of the certified version of the document within the KB. Subsequently, the federated KB computing platform may provide the identifier to the consumer device, and the consumer may use the identifier to access the certified version of the document. Additionally, and/or alternatively, the federated KB computing platform may retrieve the certified version of the document using the identifier, and present a graphical user interface (GUI) indicating the certified version of the document. This will be described in further detail below.

In one aspect, a system is provided. The system comprises: a consumer device that is configured to provide a search request for a certified version of a first document that is stored in a first knowledge base (KB) computing system; a federated KB computing platform configured to: receive the search request from the consumer device; based on the search request, determine a first document snapshot reference that comprises an identifier that identifies a storage location of the certified version of the first document within the first KB computing system, wherein the federated KB computing platform stores a plurality of document snapshot references associated with a plurality of documents that are stored in a plurality of different KB computing systems, and wherein the first KB computing system stores a plurality of versions of the first document including a latest version of the first document and the certified version of the first document; based on the determination, retrieve the identifier that identifies the storage location of the certified version of the first document within the first KB computing system; based on providing the identifier to the first KB computing system, obtain the certified version of the first document from the first KB computing system; generate a user interface (UI) based on the retrieved certified version of the first document; and cause display of the UI on the consumer device, wherein the consumer device is configured to display the UI comprising the retrieved certified version of the first document; and the first KB computing system configured to: receive the identifier from the federated KB computing platform; retrieve the certified version of the first document using the identifier; and provide the certified version of the first document to the federated KB computing platform.

Examples may include one of the following features, or any combination thereof. For instance, in some examples, each of the plurality of document snapshot references that is stored in the federated KB computing platform comprises one or more keywords associated with the plurality of documents, and wherein determining the first document snapshot reference comprises: performing a keyword search based on the search request and the one or more keywords within the plurality of document snapshot references to determine the first document snapshot reference.

In some instances, each of the plurality of document snapshot references that is stored in the federated KB computing platform comprises one or more vectors associated with the plurality of documents, and wherein determining the first document snapshot reference comprises: performing a generative artificial intelligence (AI) search based on the search request and the one or more vectors within the plurality of document snapshot references to determine the first document snapshot reference.

In some variations, the federated KB computing platform is further configured to: receive, from the first KB computing system, a registration request for a new version of the first document; generate an uncertified document snapshot reference for the new version of the first document, wherein the uncertified document snapshot reference comprises a first identifier that indicates a storage location of the uncertified version of the first document within the first KB computing system; and store the uncertified document snapshot reference within a document database of the federated KB computing platform.

In some examples, the federated KB computing platform is further configured to: subsequent to storing the uncertified document snapshot reference, provide a prompt to a subject matter expert (SME) device requesting certification for the first document; receive, from the SME device, a certification indication indicating that the new version of the first document is certified; and generate the first document snapshot reference comprising the identifier based on the certification indication from the SME, wherein the new version of the first document becomes the certified version of the first document based on the certification indication.

In another aspect, a method is provided. The method comprises: receiving, from a consumer device and by a federated knowledge base (KB) computing platform, a search request for a certified version of a first document that is stored in a first KB computing system; based on the search request, determining, by the federated KB computing platform, a first document snapshot reference that comprises an identifier that identifies a storage location of the certified version of the first document within the first KB computing system, wherein the federated KB computing platform stores a plurality of document snapshot references associated with a plurality of documents that are stored in a plurality of different KB computing systems, and wherein the first KB computing system stores one or more versions of the first document including the certified version of the first document; retrieving, by the federated KB computing platform and based on the determination, the identifier that identifies the storage location of the certified version of the first document within the first KB computing system; and using the identifier to access the certified version of the first document that is stored in the first KB computing system.

Examples may include one of the following features, or any combination thereof. For instance, in some examples, each of the plurality of document snapshot references that is stored in the federated KB computing platform comprises one or more keywords associated with the plurality of documents, and wherein determining the first document snapshot reference comprises: performing a keyword search based on the search request and the one or more keywords within the plurality of document snapshot references to determine the first document snapshot reference.

In some instances, each of the plurality of document snapshot references that is stored in the federated KB computing platform comprises one or more vectors associated with the plurality of documents, and wherein determining the first document snapshot reference comprises: performing a generative artificial intelligence (AI) search based on the search request and the one or more vectors within the plurality of document snapshot references to determine the first document snapshot reference.

In some variations, the identifier is a deep link, and wherein using the identifier to access the certified version of the first document that is stored in the first KB computing system comprises using the deep link to access the certified version of the first document.

In some examples, using the identifier to access the certified version of the first document that is stored in the first KB computing system comprises: providing, by the federated KB computing platform, the identifier to the consumer device; and accessing, by the consumer device, the certified version of the first document that is stored in the first KB computing system using the provided identifier.

In some instances, using the identifier to access the certified version of the first document that is stored in the first KB computing system comprises: retrieving, by the federated KB computing platform and using the identifier, the certified version of the first document from the first KB computing system; generating, by the federated KB computing platform, a user interface (UI) for the certified version of the first document, wherein the UI comprises one or more features and the certified version of the first document; and causing display of the UI on the consumer device.

In some variations, the method further comprises: receiving, by the federated KB computing platform and from the first KB computing system, a registration request for a new version of the first document; generating, by the federated KB computing platform, an uncertified document snapshot reference for the new version of the first document, wherein the uncertified document snapshot reference comprises a first identifier that indicates a storage location of the uncertified version of the first document within the first KB computing system; and storing, by the federated KB computing platform, the uncertified document snapshot reference within a document database of the federated KB computing platform.

In some examples, the method further comprises: receiving, from an author device, author information associated with the new version of the first document, wherein the author information comprises a title, the first identifier, one or more keys, and one or more vectors associated with the new version of the first document, and wherein generating the uncertified document snapshot reference is based on the author information.

In some instances, the method further comprises: subsequent to storing the uncertified document snapshot reference, providing, by the federated KB computing platform, a prompt to a subject matter expert (SME) device requesting certification for the first document; receiving, from the SME device and by the federated KB computing platform, a certification indication indicating that the new version of the first document is certified; and generating the first document snapshot reference comprising the identifier based on the certification indication from the SME, wherein the new version of the first document becomes the certified version of the first document based on the certification indication.

In some variations, the method further comprises: based on the prompt, obtaining, by the SME device, a list of document versions for the first document, wherein the list of document versions comprises a previously certified version of the first document and the new version of the first document; receiving, by the SME device, input from an SME comprising certification indication for the new version of the first document; and providing, by the SME device, the certification indication to the federated KB computing platform.

In some examples, the input from the SME further comprises certification information indicating a name of the SME, a date of the certification indication, and certification time boundaries, and wherein generating the first document snapshot reference comprises: updating the uncertified document snapshot reference within the document database based on the certification information to generate the first document snapshot reference; and storing the first document snapshot reference in the document database.

In some instances, the first KB computing system stores a plurality of versions of the first document, wherein the plurality of versions of the first document comprises the certified version of the first document and a latest version of the first document, wherein the certified version of the first document is different from the latest version of the first document.

In some variations, the first KB computing system stores a plurality of versions of the first document, wherein the plurality of versions of the first document comprises the certified version of the first document that is also a latest version of the first document.

In some examples, the method further comprises: prior to determining the first document snapshot reference, receiving, from a subject matter expert (SME) device, a certification indication indicating to certify a version of the first document that is not a latest version of the first document; and generating the first document snapshot reference comprising the identifier based on the certification indication from the SME device, wherein the version of the first document becomes the certified version of the first document based on the certification indication.

In yet another aspect, a non-transitory computer-readable medium having processor-executable instructions stored thereon is provided. The processor-executable instructions, when executed, facilitate: receiving, from a consumer device, a search request for a certified version of a first document that is stored in a first knowledge base (KB) computing system; based on the search request, determining a first document snapshot reference that comprises an identifier that identifies a storage location of the certified version of the first document within the first KB computing system, wherein a federated KB computing platform stores a plurality of document snapshot references associated with a plurality of documents that are stored in a plurality of different KB computing systems, and wherein the first KB computing system stores one or more versions of the first document including the certified version of the first document; retrieving, based on the determination, the identifier that identifies the storage location of the certified version of the first document within the first KB computing system; and using the identifier to access the certified version of the first document that is stored in the first KB computing system.

All examples and features mentioned herein may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3A is a simplified block diagram depicting an exemplary federated knowledge base computing platform in accordance with one or more examples of the present application.

FIG. 3B shows an exemplary certified document snapshot reference in accordance with one or more examples of the present application.

FIG. 3C is a simplified block diagram depicting a relationship between a document database of the federated knowledge base computing platform and the knowledge bases in accordance with one or more examples of the present application.

FIG. 4 is an exemplary process for performing federated knowledge governance for an enterprise organization in accordance with one or more examples of the present application.

FIG. 5 is an exemplary process for performing certification of documents in accordance with one or more examples of the present application.

FIGS. 6A and 6B show an exemplary event sequence for performing federated knowledge governance for an enterprise organization in accordance with one or more examples of the present application.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on”or “based at least partially on”.

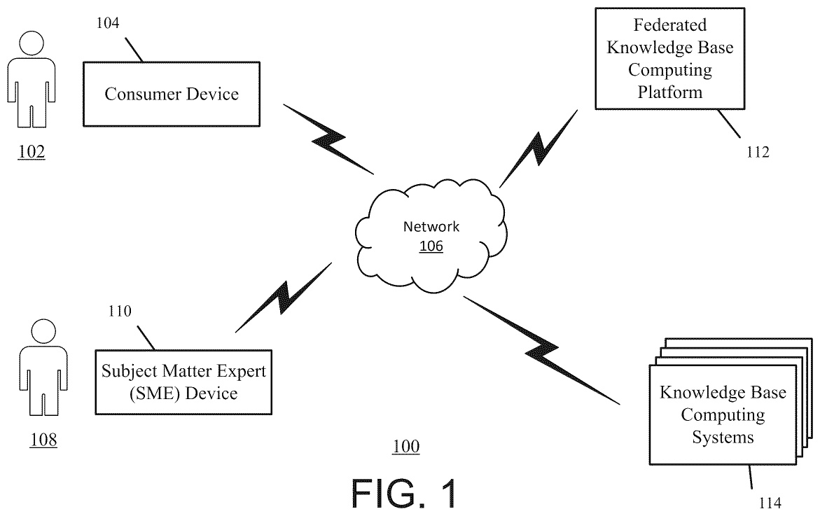

Systems, methods, and computer program products are herein disclosed that perform federated knowledge governance for an enterprise organization. FIG. 1 is a simplified block diagram depicting an exemplary environment in accordance with an example of the present application. The environment 100 includes a consumer 102, a consumer device 104 (e.g., a computing device), a network 106, a subject matter expert (SME) 108, an SME device 110, a federated knowledge base (KB) computing platform 112, and KB computing systems 114. Although the entities within environment 100 may be described below and/or depicted in the FIGs. as being singular entities, it will be appreciated that the entities and functionalities discussed herein may be implemented by and/or include one or more entities. For instance, the federated KB computing platform 112 may include a plurality of computing devices, systems, platforms, repositories, and/or servers that are spread across multiple different geographical locations and communicate with each other using direct connections and/or the network 106.

The entities within the environment 100 such as the consumer device 104, the SME device 110, the federated KB computing platform 112, and the KB computing systems 114 may be in communication with other devices and/or systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100 The consumer 102 may operate, own, and/or otherwise be associated with the consumer device 104. For example, the consumer 102 may seek to access data that is authored, published, certified, controlled, managed, updated, and/or otherwise associated with an enterprise organization. The enterprise organization may be any type of corporation, company, organization, and/or other institution that provides one or more goods and/or services. For instance, the enterprise organization may provide multiple different services such as a grocery pick-up service, a prescription pick-up service (e.g., the enterprise organization may provide prescriptions / medications to a user), an insurance service (e.g., the enterprise organization may provide insurance to a user), a streaming service (e.g., the enterprise organization may provide for streaming videos, television shows, and so on to a user), and/or other services.

The enterprise organization may seek to store data within databases and/or repositories that the enterprise organization owns and/or manages. For example, each work team (e.g., internal departments and/or groups of employees) of the enterprise organization may be responsible for different aspects or tasks. For instance, one work team may provide the prescription pick-up service to users, and another work team may provide insurance services to users. Additionally, and/or alternatively, the work team may include a department such as an HR department or IT department. Each work team may generate (e.g., author) data such as documents (e.g., policy) that facilitate their work flow. The documents may be and/or include any type of static documentation file that is associated with a revision tracking system. For example, the documents may be and/or include, but are not limited to, a text file, a WORD file, a Markdown (md) file, a VISIO diagram file, and/or other types of static documentation files. In some instances, the document may be associated with (e.g., about) an API (e.g., a confluence document describing API endpoints, behavior, usage, patterns, and so on).

For example, the HR department may generate/author/manage data such as policy documents for a vacation policy for employees and/or travel policies for employees. In another example, the IT department may generate/author/manage data such as policy documents for security policies (e.g., Internet websites that are unauthorized or software applications that an employee are not allowed to download onto their work computers). In yet other examples, a work team may generate/author/manage projects (e.g., APIs and/or software applications such as a tax calculator API that may be used to calculate taxes for individuals). The work team may generate documents such as md files to describe the project.

The consumer 102 may seek to access data associated with an enterprise organization. For example, the consumer 102 may be an employee of the enterprise organization and may seek to access the vacation policy that was authored by the HR department, may seek to access documentation regarding a project (e.g., an md file associated with the tax calculator API). As such, using the consumer device 104, the consumer 102 may provide a request to the federated KB computing platform 112 to access the data.

The consumer device 104 is and/or includes, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The consumer device 104 may be able to execute software applications and/or programs. Additionally, and/or alternatively, the consumer device 104 may be configured to operate a web browser to connect to a web page and/or applications.

The KB computing systems 114 are KBs that are associated with the enterprise organization. For example, each work group may generate data (e.g., policy documents, md files, and/or other documents) that is associated with their individual work flow. For instance, the HR department may author policies such as vacation policies for employees of the enterprise organization, and another work team may author documents about one or more APIs/software applications that the team is currently developing and/or managing. The KB computing systems 114 may store the data that is authored by the different work teams. The enterprise organization may include numerous different work teams, and each KB computing system 114 may be associated with one or more of the work teams. For instance, the work team may generate data (e.g., author documents associated with a tax calculator API and/or software applications), and store the generated data within a KB computing system 114 that is owned, managed, and/or associated with the work team.

The KB computing systems 114 includes and/or is implemented using one or more computing devices, computing platforms, cloud computing platforms, systems, servers, repositories, databases, and/or other apparatuses. For instance, in some examples, the KB computing systems 114 may be a set of repositories and/or databases that store data for the different work teams of the enterprise organization. In other examples, the KB computing systems 114 may further include one or more computing devices that the work teams may use to generate the data (e.g., author the documents). In some examples, the KB computing systems 114 may be implemented as engines, software functions, and/or applications. In other words, the functionalities of the KB computing systems 114 may be implemented as software instructions stored in storage (e.g., memory) and executed by one or more processors.

The federated KB computing platform 112 is a computing platform that is configured to perform federated knowledge governance. For example, based on a request from the consumer device 104, the federated KB computing platform 112 may provide access to the requested data from the KB computing systems 114. For example, the request from the consumer device 104 may be to review a travel policy implemented by the enterprise organization. The federated KB computing platform 112 may provide information indicating the travel policy to the consumer device 104. For instance, the work team (e.g., the HR department) may prepare a certified version of the travel policy (e.g., a version of the travel policy that is currently being implemented by the enterprise organization). Furthermore, the work team may continue to work on the travel policy (e.g., providing updates that have not been approved and/or certified). As such, the KB computing system 114 associated with the work team may store multiple versions of the travel policy including the latest version as well as the certified version. A consumer 102 might not care about the latest version of the travel policy that has not been certified and/or implemented, and instead is requesting the certified version. Thus, based on a request, the federated KB computing platform 112 may provide the certified version of the travel policy to the consumer 102. For example, the federated KB computing platform 112 may store snapshot references of data from the KB computing systems 114, such as snapshot references of the certified and/or uncertified versions of the data. The snapshot references may include and/or indicate identifiers indicating a storage location of the data, and the identifiers may be and/or include links, deep links, and/or other identifiers that indicate where the data is stored within the KB computing systems 114. For instance, the federated KB computing platform 112 may store a snapshot reference of the certified version of the travel policy. Using the snapshot reference, the federated KB computing platform 112 may retrieve the travel policy from the KB computing system 114 and provide the travel policy to the consumer device 104. Additionally, and/or alternatively, the federated KB computing platform 112 may provide the snapshot reference and/or identifier to the consumer device 104, and the consumer device 104 may access the document using the snapshot reference.

In some examples, the consumer 102 may request access to another type of document such as an md file associated with a project. For instance, the work team may work on one or more projects and prepare documentation to describe the project. Similar to the above, the work team may store multiple versions of the md file for the project in KB computing system 114, including a latest version of the md file and a certified version of the md file, which may or may not be the same version.

The federated KB computing platform 112 includes and/or is implemented using one or more computing devices, computing platforms, cloud computing platforms, systems, servers, databases, repositories, and/or other apparatuses capable of performing federated knowledge governance. In some examples, the federated KB computing platform 112 may be implemented as engines, software functions, and/or applications. In other words, the functionalities of the federated KB computing platform 112 may be implemented as software instructions stored in storage (e.g., memory) and executed by one or more processors.

In some examples, the work team may seek certify data (e.g., the documents such as the policy documents). An SME 108 may use an SME device 110 to certify the data. For example, a document may be “certified” when the document is asserted to be valid and canonical for a specified period of time by an expert (e.g., SME 108) that is empowered to certify documents in a given domain. In other words, the certification process may be domain-specific. Thus, for example, the HR lead may be an SME 108 that certifies an HR policy document for a period of time (e.g., from Jan. 1, 2024 to Jan. 1, 2025), and for that period of time, the certified version of the document may be considered definitive. A document may be de-certified early (e.g., if the policy changes early) or re-certified again for a subsequent time period (e.g., if the policy does not change).

In some instances, the SME device 110 may communicate directly with the KB computing system 114 to certify the data. For example, the SME 108, using the SME device 110, may certify the documents such as the policy documents. In other instances, the SME device 110 may communicate with the federated KB computing platform 112 to certify the data within the KB computing systems 114. The certification process will be described in further detail below.

The SME device 110 is and/or includes, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The SME device 110 may be able to execute software applications and/or programs. Additionally, and/or alternatively, the SME device 110 may be configured to operate a web browser to connect to a web page and/or applications.

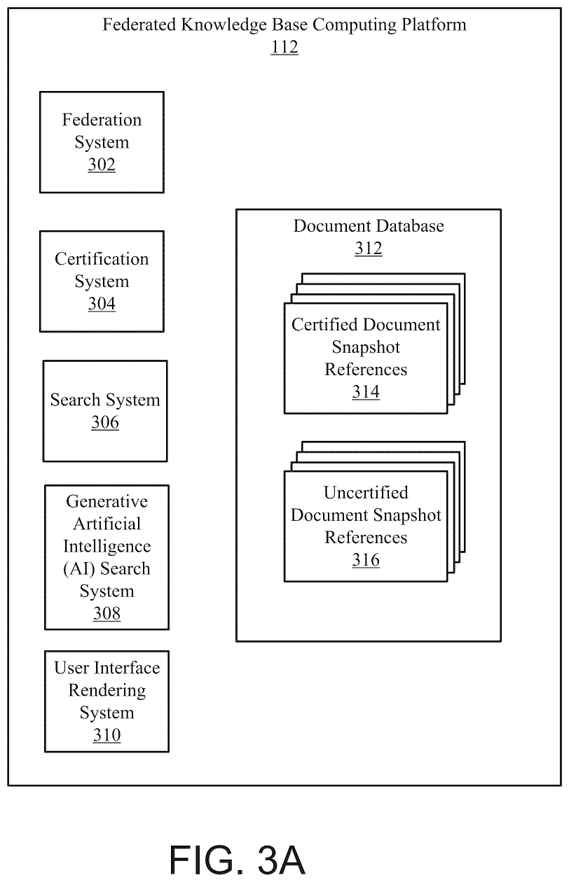

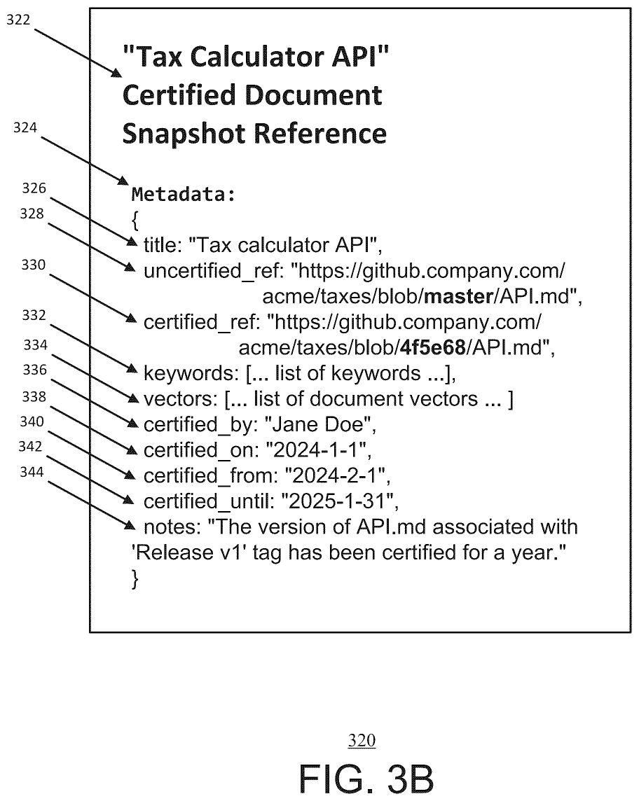

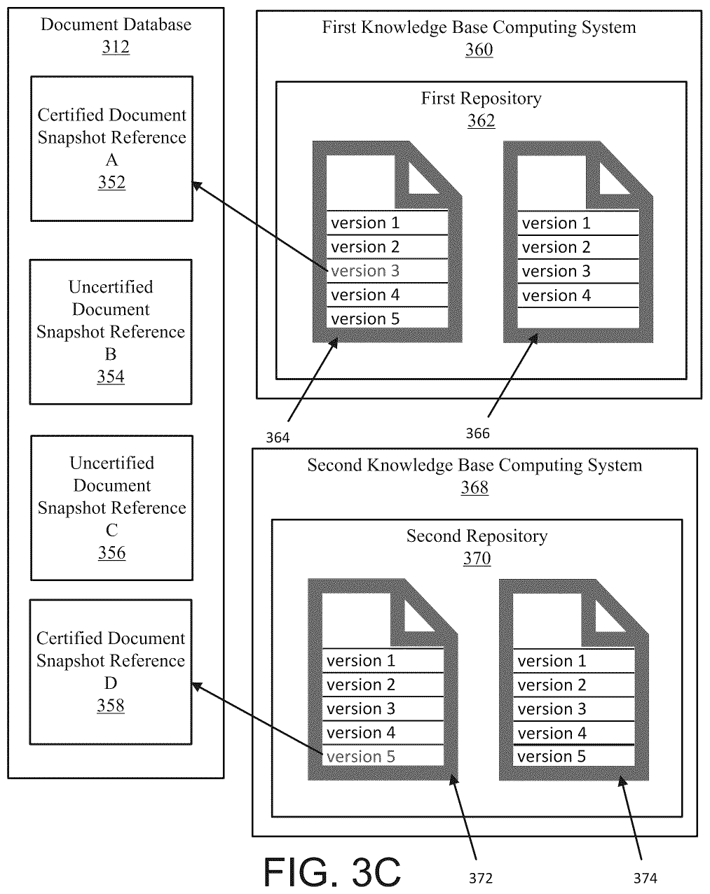

It will be appreciated that the exemplary environment depicted in FIG. 1 is merely an example, and that the principles discussed herein may also be applicable to other situations—for example, including other types of institutions, organizations, devices, systems, and network configurations. For example, in some variations, the functionalities of the federated KB computing platform 112 may be separated into multiple different entities, which is described in further detail in FIGS. 3A-3C below.

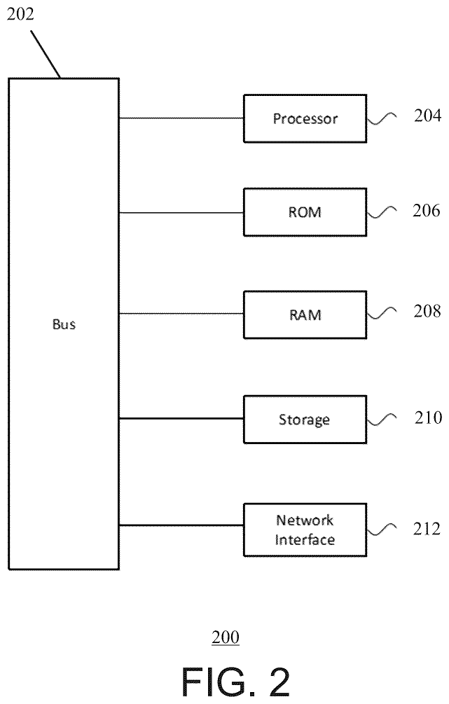

FIG. 2 is a block diagram of an exemplary system and/or device 200 within the environment 100. The device/system 200 includes one or more processors 204, such as one or more CPUs, controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

FIG. 3A is a simplified block diagram depicting an exemplary federated KB computing platform 112 in accordance with one or more examples of the present application. The federated KB computing platform 112 includes a federation system 302, a certification system 304, a search system 306, a generative artificial intelligence (AI) search system 308, a user interface rendering system 310, and a document database 312. The document database 312 includes certified document snapshot references 314 and uncertified document snapshot references 316. Each of the federation system 302, the certification system 304, the search system 306, the generative AI search system 308, the user interface rendering system 310, and/or the document database 312 may include one or more computing systems, devices, apparatus, servers, databases, repositories, and/or other entities that are configured to perform one or more functionalities for the enterprise organization.

For instance, the federation system 302 (e.g., a federation engine) may be configured to locate and/or access a given document repository, list/find/retrieve documents from the document repository, parse the document history to determine versions of the document, and/or create deep links to the different versions of the document. For instance, the federated system 302 may include (e.g., track and/or store) a list of federated document repositories, and may further include information associated with each of the repositories such as a specific type of repository (e.g., whether the document repository is a SHAREPOINT repositories, GITHUB repositories, MEDIAWIKI instances, and/or other types of repositories) and/or configuration information of the repository. For instance, the type of repository may be associated with a particular code module, which may “know” how to track and reference documents on a given document storage platform, how to parse and construct valid deep links, and so on. For example, GITHUB repositories may use a uniform resource locator (URL) (e.g., a GIT URL) that includes document global unique identifiers (GUID) within a deep link. Thus, a system may have to actually parse the repository history to determine which version of the document is associated with the deep link. Therefore, the federation system 302 may include a GIT module that is configured to parse the revision history, including multiple branches/tags and their splits/merges, and associate it with blob deep links. In another example, MEDIAWIKI may directly embed versions within the URL. Thus, the federation system 302 may include a MEDIAWIKI module that is configured to scan the document revision history and extract deep links from it directly.

Therefore, in some examples, the federated system 302 may be configured to locate and access a given document repository. Following, the federated system 302 may list, find (e.g., determine), and/or retrieve documents from the given document repository. Further, the federated system 302 may parse the document history of the document and/or create deep links to a specific historical version of the document. In other words, in some variations, the federated system 302 may find, access (e.g., using properly authorized credentials and/or another access method), and/or process information in the documentation repository. Additionally, and/or alternatively, the federated system 302 may include configuration information, such as configuration information associated with the repository URL (repo URL), type of repository (e.g., GITHUB repository and/or MEDIAWIKI instances), credentials, and/or additional metadata to facilitate processing such as the document tagging scheme and/or folder structure.

The certification system 304 (e.g., certification engine) may be configured to facilitate the certification process for data (e.g., documents) within the KB computing systems 114. For example, as mentioned above, in some variations, the SME device 110 may communicate directly with the KB computing systems 114 to certify the data/documents. In other variations, the SME device 110 may communicate with the certification system 304 to facilitate the certification of the documents. For example, the certification system 304 may provide a request to the SME device 110 to certify a document. The SME device 110, using the certification system 304 and/or based on directly communicating with the KB computing systems 114, may retrieve a list of versions of the document from the KB computing systems 114, and identify a version that is suitable for certification (e.g., the latest version is suitable for certification). The SME device 110 may provide an indication to the certification system 304 indicating validation of the document and/or additional information. Additionally, and/or alternatively, the certification system 304 may generate metadata associated with the validation such as the SME 108 that certified document, the certification date and how long the document is certified for, and/or other notes/information (e.g., based on the additional information provided by the SME device 110).

The search system 306 and the generative AI search system 308 may perform a search for data requested by the consumer device 104. For example, the consumer device 104 may provide a request to the federated KB computing platform 112 to access a document that is stored in the KB computing systems 114. The search system 306 and/or the generative AI search system 308 may be used to fulfill the request. For instance, the search system 306 may use one or more searching methods, processes, and/or algorithms to search the document database 312 for a document snapshot reference (e.g., a certified document snapshot reference 314) that fulfills the request. For example, the request from the consumer device 104 may indicate a travel policy. The search system 306 may search the document database 312 for a snapshot reference for the travel policy. The generative AI search system 308 may function similarly to the search system 306 except that the generative AI search system 308 may use generative AI to perform the search of the document database 312 for the snapshot reference. Subsequently, the search system 306 and/or the generative AI search system 308 may provide the retrieved snapshot reference back to the consumer device 104, and the consumer device 104 may use the snapshot reference to access the document from the KB computing systems 114.

In some examples, instead of the providing the retrieved snapshot reference to the consumer device 104, the federated KB computing platform 112 may retrieve the actual document (e.g., the md file and/or the travel policy) from the KB computing systems 114. For example, the user interface (UI) rendering system 310 may render a UI for the consumer device 104. For instance, the UI rendering system 310 may render a UI for the consumer device that includes the retrieved document from the KB computing system 114 as well as incorporating other aspects such as navigation, search, common styling, branding, and/or other UI features. In other words, in some variations, the UI rendering system 310 may cause display of a UI on the consumer device 104 based on the request, and the UI may include the requested document and other features and/or aspects.

The document database 312 may be one or more databases and/or repositories that store snapshot references for the enterprise organization. For instance, the document database 312 may store certified document snapshot references 314 and/or uncertified document snapshot references 316 indicating storage locations of the actual documents within the KB computing system 114. For example, after a document version has been authored and registered with the KB computing system 114. The federated KB computing platform 112 (e.g., the federation system 302 and/or the certification system 304) may receive an indication of the new document version, and store a snapshot reference to the new document version into the document database 312. Initially, the snapshot reference to the new document version may be an uncertified document snapshot reference 316. Then, using the certification system 304, the SME 108 may certify the new document version, and the federated KB computing platform 112 may receive an indication the certification. The federated KB computing platform 112 may register the uncertified document snapshot reference 316 as a certified document snapshot reference 314. An example of the snapshot reference and the relationship between the snapshot references and the KB computing systems 114 will be described in further detail in FIGS. 3B and 3C.

FIG. 3B shows an exemplary certified document snapshot reference 320 in accordance with one or more examples of the present application. For example, FIG. 3B shows a snapshot reference 320 for a document (e.g., md file) associated with a Tax Calculator API. The header 322 of the snapshot reference 320 indicates that the snapshot reference 320 is for a “Tax Calculator API”, and that the snapshot reference 320 is a “Certified Document Snapshot Reference.” The snapshot reference 320 further includes metadata 324. The metadata 324 includes a title 326 for the document, which as shown is “Tax calculator API.” The metadata 324 further includes identifiers including an uncertified identifier 328 (e.g., “uncertified_ref”) and a certified identifier 330 (e.g., “certified_ref”). As mentioned above, the identifiers 328 and 330 may be, in some examples, deep links that indicate storage locations of the actual documents within the KB computing systems 114. The metadata 324 may further include keywords 332 and/or vectors 334 that are associated with the document, and the search system 306 and/or the generative AI search system 308 may search for the requested document snapshot reference using the keywords 332 and/or vectors 334. For instance, the keywords 332 may be used for traditional keyword search (e.g., using the search system 306). The vectors 334 may be used by the generative AI search system 308. The metadata 324 may further include certification information 336-342 associated with the certification of the document. The certification information may include a name 336 of an SME 108 that certified the document (e.g., “Jane Doe”), a date of certification 338 such as “2024-1-1,” and a duration of the certification 340-342 (e.g., certified from “2024-2-2” to “2025-1-31”). Further, the certification information may include notes 334 that may be provided by the SME 108, the SME device 110, and/or others. The snapshot reference 320 is merely an example, and in other variations, a snapshot reference may include additional and/or alternative information.

In some examples, using the identifiers 328 and/or 330, the federated KB computing platform 112 and/or the consumer device 104 may access the requested data. For example, the identifier 328 may indicate a “master” API Markdown (md) file associated with the Tax Calculator API, and the “master” API md file may be an uncertified version of the document. The identifier 330 may indicate a certified version of the md file that is stored within the KB computing system 114. For example, the KB computing system 114 may store multiple versions of a document (e.g., API md files for the Tax calculator service), and each version may be associated with an identification such as “1a2b3c,” “2d3e4f,” “4f5e68,” and “7df9a2.” The versions may be “initial commit” versions, “pre-release” versions, and/or “release” versions. Currently, the certified version may be the “release version” that is indicated by the identification “4f5e68.” Thus, the identifier 330 may indicate a certification version of the document (e.g., API md), which is identified within the KB computing system 114 using the identification “4f5e68.”

FIG. 3C is a simplified block diagram depicting a relationship between a document database of the federated knowledge base computing platform and the knowledge bases in accordance with one or more examples of the present application. For instance, FIG. 3C shows the document database 312 as well as two KB computing systems 114 (e.g., the first KB computing system 360 and the second KB computing system 368). Each of the KB computing systems 360 and 368 include repositories 362 and 370 (e.g., a first and second repository 362 and 370).

As shown, the document database 312 includes certified and uncertified snapshot references. For example, the document database 312 includes a certified document snapshot reference A 352, an uncertified document snapshot reference B 354, an uncertified document snapshot reference C 356, and a certified document snapshot reference D 358. Furthermore, the KB computing systems 360 and 368 include repositories 362 and 370 that show the actual storage of each of the versions of the documents. For example, the first repository 362 may store document A 364 and document B 366. Further, as shown, the first repository 362 may store five versions of document A 364 and four versions of document B 366. In addition, the third version of document A 364 may be the certified version, and no version of document B 366 may be certified. Thus, the certified document snapshot reference A 352 may include metadata and/or an identifier that indicates a storage location of a third version of document A 364 within the first repository 362 (e.g., the first repository 362 that stores the certified version of document A 364). Further, the uncertified document snapshot reference B 354 may include an identifier that indicates that a storage location of the latest version of document B 366 (e.g., the first repository 362 that stores version four of document B 366).

Similarly, the document database 312 may store certified and uncertified snapshot references for multiple different KB computing systems 114 such as the second knowledge base computing system 368. For example, the uncertified document snapshot reference C 356 may include an identifier indicating a storage location (e.g., the second repository 370) for the document C 374. The certified document snapshot reference D 358 may include an identifier indicating a storage location (e.g., the second repository 370) for the document D 372. Further, the identifier of the uncertified document snapshot reference C 356 may be the latest version of document C 374, which might not be certified. For instance, as shown, the document C 374 may include five versions and an SME 108 might not have certified any of the versions at this time. The identifier of the certified document snapshot reference D 358 may be the latest version of document D 372, which may also be certified version of document D 372. For example, in some instances, the latest version of a document that is stored within the KB computing systems 114 may also be the certified version of the document.

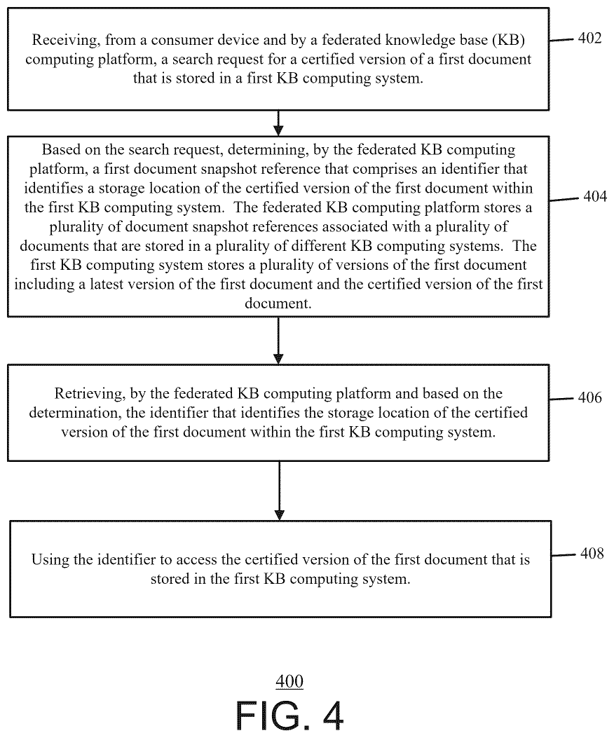

FIG. 4 is an exemplary process for performing federated knowledge governance for an enterprise organization in accordance with one or more examples of the present application. One or more blocks from process 400 may be performed by the federated KB computing platform 112 and/or the consumer device 104 of environment 100 shown in FIG. 1. It will be recognized that any of the following blocks may be performed in any suitable order, and that the process 400 may be performed in any suitable environment. The descriptions, illustrations, and processes of FIG. 4 are merely exemplary and the process 400 may use other descriptions, illustrations, and processes for performing federated knowledge governance for an enterprise organization.

At block 402, the federated KB computing platform 112 receives, from a consumer device 104, a search request for a certified version of a first document that is stored in a first KB computing system. The first KB computing system may be one of a plurality of KB computing systems 114. For example, as mentioned above, the consumer 102 may use the consumer device 104 to request a document (e.g., a certified version of the document) that is stored in one of the KB computing systems 114 of the enterprise organization. For instance, authors may generate data such as documents, including multiple versions of the documents, and store the documents into one of the plurality of KB computing systems 114. Further, an SME 108 may certify one of the versions of the documents. In some examples, the certified version of the document might not be the latest version of the document. For example, an SME 108 may certify a document associated with a release (e.g., a 1.0 release of a software application/API). However, the author may continue to work on the document even after release. But, the continued work on the document might not be certified by the SME 108 until stability is achieved. As such, the KB computing system 114 (e.g., the first KB computing system) may store multiple versions of the documents, including a latest version of the document and a certified version of the document, and the latest and certified versions of the document may be the same version of the document, but may also be different versions of the document. At block 402, the federated KB computing platform 112 receives a request for a certified version of a first document, which may or might not be the latest version of the document.

At block 404, based on the search request, the federated KB computing platform 112 determines a first document snapshot reference that comprises an identifier that identifies a storage location of the certified version of the first document within the first KB computing system. The federated KB computing platform stores a plurality of document snapshot references associated with a plurality of documents that are stored in a plurality of different KB computing systems. The first KB computing system stores a plurality of versions of the first document including a latest version of the first document and the certified version of the first document.

For example, referring back to FIGS. 3A-3C, the federated KB computing platform 112 may include a document database 312 that stores multiple different certified and uncertified document snapshot references 314 and 316. The snapshot references (e.g., snapshot reference 320) may indicate a storage location of a version of a document. Based on the search request, the federated KB computing platform 112 may determine a snapshot reference associated with the search request. For example, the federated KB computing platform 112 may determine that the consumer 102 is requesting document A 364, and determine the snapshot reference 352 indicating a storage location of a certified version of the document A 364 (e.g., the third version that has been certified). As shown in FIG. 3C, the certified version of document A 364 is not the latest version of document A 364 (e.g., the third version is certified and the latest version is the fifth version). In other examples, such as if the consumer 102 is requesting document D 372, the latest version of the document D 372 may be the same as the certified version (e.g., both of them may be version five). The federated KB computing platform 112 may determine the certified document snapshot reference associated with the requested document (e.g., the certified document snapshot reference A 352 associated with the requested document 364), and retrieve the snapshot reference from the document database 312. In some examples, as mentioned above, the federated KB computing platform 112 may use the search system 306 and/or the generative AI search system 308 to determine the certified document snapshot reference that is associated with the search request from the consumer device 104.

At block 406, the federated KB computing platform 112 retrieves, based on the determination from block 404, the identifier that identifies the storage location of the certified version of the first document within the first KB computing system. For example, based on determining a certified document snapshot reference (e.g., the certified document snapshot reference A 352) associated with document A 364 that is within the first repository 362 of the first knowledge base computing system 360, the federated KB computing platform 112 may retrieve the certified document snapshot reference. As mentioned in FIG. 3B, the certified document snapshot reference may include identifiers 328 and 330, including an identifier 330 indicating a storage location of the certified version of the document (e.g., a deep link indicating the certified version of the document). In some examples, the federated KB computing platform 112 may retrieve the entire certified document snapshot reference. In other examples, the federated KB computing platform 112 may retrieve only the text associated with the identifier 330 (e.g., the deep link indicating the storage location of the certified version of the document).

At block 408, the federated KB computing platform 112 and/or the consumer device 104 may use the identifier to access the certified version of the first document that is stored in the first KB computing system. In some examples, after retrieving the identifier (e.g., identifier 330), the federated KB computing platform 112 may provide the identifier to the consumer device 104. Then, at block 408, the consumer device 104 may use the identifier (e.g., deep link) to access the certified version of the document. For example, using the deep link, the consumer device 104 may access the document A that is stored in the first repository 362 of the first knowledge base computing system 360.

In other examples, the federated KB computing platform 112 may include the UI rendering system 310, and may render a UI for the consumer device 104. For example, at block 408, the federated KB computing platform 112 may access (e.g., retrieve) the version of the document indicated by the identifier (e.g., retrieve version three of the document A 364 that is indicated by the determined certified document snapshot reference A 352). For instance, the federated KB computing platform 112 may provide a request to a KB computing system 114, and the request may include the identifier. The KB computing system 114 may retrieve the certified version of the first document using the identifier, and provide the certified version of the first document to the federated KB computing platform 112. After, using the UI rendering system 310, the federated KB computing platform 112 may render a UI for the consumer device 104 that displays the requested document as well as other features (e.g., navigation, search, common styling, branding, and/or other UI features). The consumer 102 may review the requested document (e.g., the certified version of the document) on the UI that is displayed on the consumer device 104.

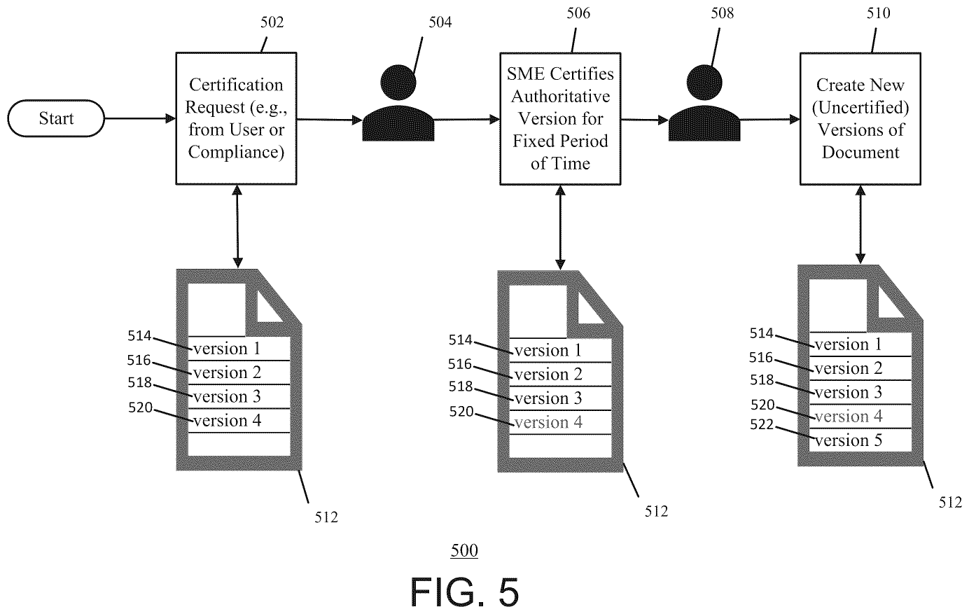

FIG. 5 is an exemplary process 500 for performing certification of documents in accordance with one or more examples of the present application. The process 500 may be performed by one or more entities of environment 100 shown in FIG. 1. It will be recognized that any of the following blocks may be performed in any suitable order, and that the process 500 may be performed in any suitable environment. The descriptions, illustrations, and processes of FIG. 5 are merely exemplary and the process 500 may use other descriptions, illustrations, and processes for performing federated knowledge governance for an enterprise organization.

For example, FIG. 5 shows process 500 including blocks 502-510 for authoring and certifying versions of documents. Further, similar to FIG. 3C, the versions for a document 512 at different stages of the certification process 500 are shown. For instance, initially, at block 502, a certification request (e.g., from a user or compliance) is provided. For example, a document 512 may include a plurality of versions such as the four versions 514-520. Each version of the document 512 may be stored within a KB computing system 114. Initially, at block 502, none of the versions 514-520 of the document 512 may be certified.

At block 504, the SME 108, using the SME device 110, may identify the authoritative version. For example, the SME device 110 may retrieve all versions 514-520 of the document 512 and identify the authoritative version of the document based on a review.

At block 506, the SME 108, using the SME device 110, certifies the authoritative version of the document for a fixed period of time (e.g., for the next year). For example, the SME device 110 may provide an indication that the fourth version 520 of the document 512 is certified. As such, at block 506, one of the versions of the document 512 (e.g., the fourth version 520) is certified. In some examples, the SME 108, using the SME device 110, may certify the latest version of the document. In other examples, the SME 108, using the SME device 110, may certify a version of the document that is not the latest version of the document. For example, the SME device 110 may provide a certification indication to the federated KB computing platform 112 to certify a version of the document that is not the latest version of the document. Then, the federated KB computing platform 112 may generate a document snapshot reference based on the certification indication from the SME device 110.

At block 508, an author, using an authoring device (e.g., an authoring device that is part of the KB computing system 114 that stores the versions 514-520 of the document 512 and/or that is separate from the KB computing system 114), may continue to edit the document 512.

By continuing to edit the document 512, at block 510, the author, using the authoring device, may author another version 522 of the document 512. This new version might not be certified by the SME 108 at block 510. However, process 500 may repeat, and in the next iteration, the SME 108 may certify this new version 522 of the document 512 instead, and the version 520 of the document 512 may be retired.

During and/or following the process 500, process 400 may be performed and the consumer 102 may seek to access a version of the document. The federated KB computing platform 112 may provide the certified version of the document (e.g., the fourth version 520 of the document 512) based on the request from the consumer device 104.

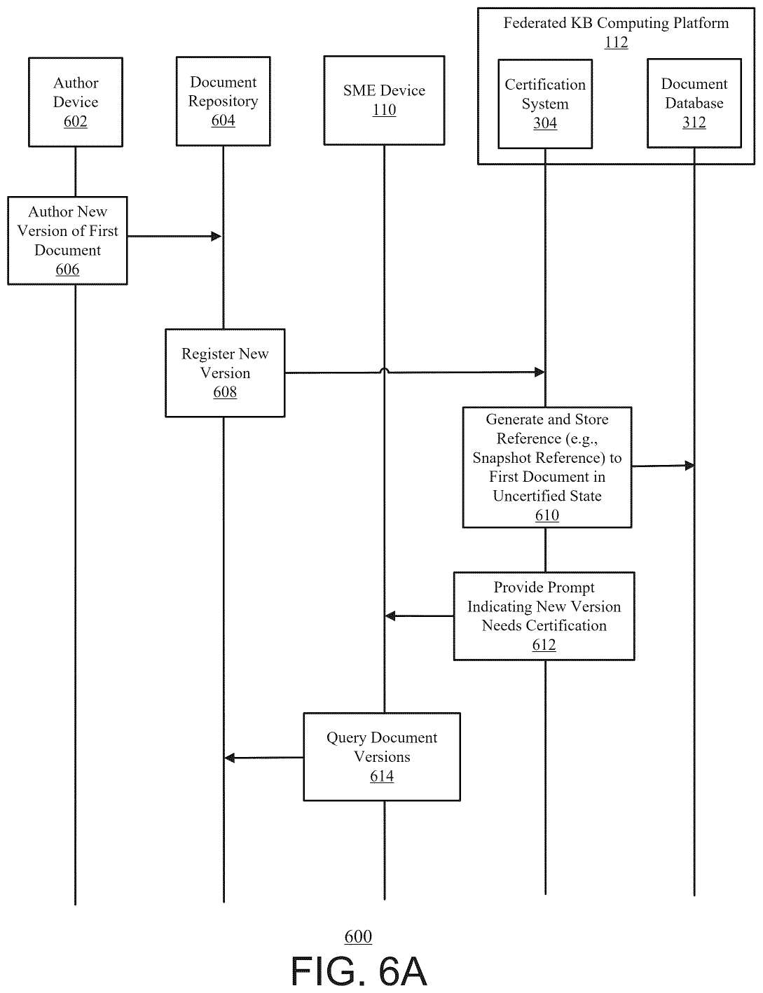

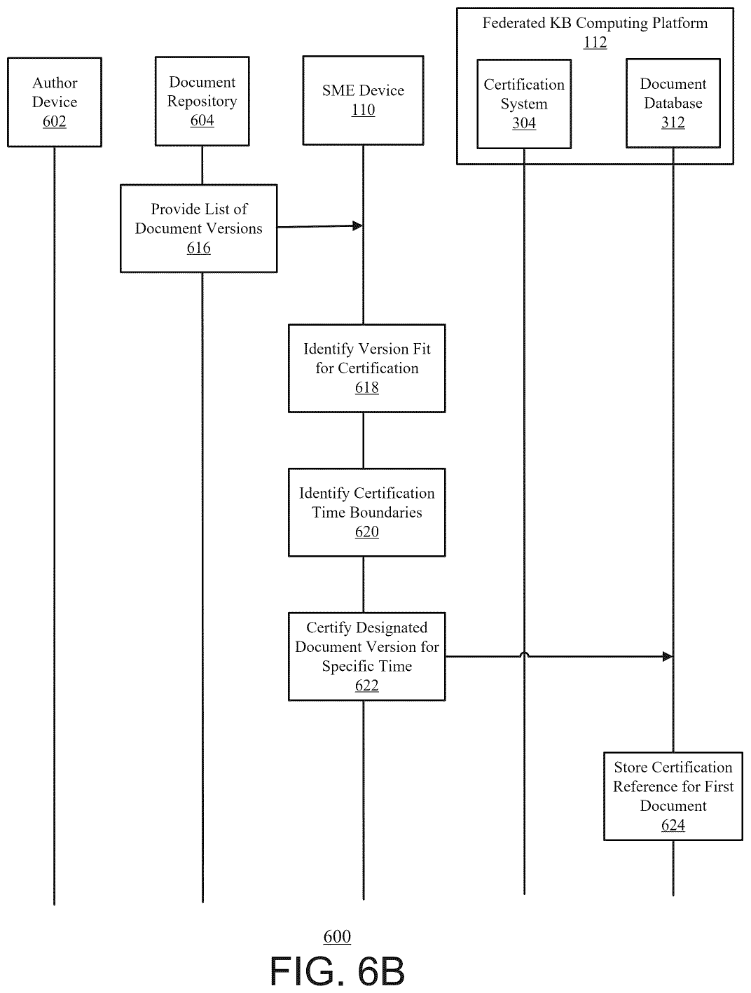

FIGS. 6A and 6B show an exemplary event sequence 600 for performing federated knowledge governance for an enterprise organization in accordance with one or more examples of the present application. However, the event sequence 600 is merely an example and other types of event sequences are contemplated herein including by performing any of the following blocks in any suitable order. The event sequence 600 includes operations, processes, and/or functions that are performed by one or more entities. For example, the event sequence 600 includes blocks performed by an author device 602, a document repository 604, an SME device 110, and a federated KB computing platform 112, which includes a certification system 304 and a document database 312. As mentioned previously, the KB computing systems 114 may include databases and/or repositories such as the document repository 604. Additionally, and/or alternatively, the KB computing systems 114 may include the author device 602 (e.g., a device for an author to generate a document). In some examples, the author device 602 may be separate from the KB computing systems 114.

In operation, at block 606, the author device 602 authors a new version of a first document. For example, as described above, a KB computing system 114 may include a repository (e.g., document repository 604) that stores documents, including one or more versions of the document. The stored versions of the document may include a certified version and a latest version, which may or may not be the same version. In some instances, prior to block 606, the document repository 604 may already store one or more versions of the first document, and at block 606, the author device 602 may author a new version of the first document. This new version may be uncertified at this point. In other instances, the document repository 604 might not store any versions of the first document. At block 606, the author device 602 may author a new and first version of the first document, and store the first version in the document repository 604.

At block 608, the document repository 604 (e.g., the KB computing system 114) registers the new version. For example, after receiving the new version of the first document and storing the new version in memory, the document repository 604 may seek to register the new version with the federated KB computing platform 112 (e.g., the certification system 304). To register the new version, the document repository 604 may provide information (e.g., a registration request) to the federated KB computing platform 112.

At block 610, the certification system 304 generates and stores, in the document database 312, a reference (e.g., snapshot reference) to the first document in an uncertified state. For example, referring back to FIG. 3A, the document database 312 may store certified document snapshot references 314 and uncertified document snapshot references 316. Here, given that the new version of the document that was authored at block 606 has not been certified, the certification system 304 may generate an uncertified document snapshot reference 316 for the new version. In some examples, the uncertified document snapshot reference 316 may include metadata that indicates an identifier (e.g., identifier 328 from FIG. 3B) that indicates a storage location of the new version of the document and/or other information (e.g., author information from an author). For instance, when registering the new version at block 608, the document repository 604 may provide an identifier (e.g., a deep link) that indicates the storage location of the new version of the document that was authored at block 606. The certification system 304 may generate a snapshot reference that includes this identifier and store the generated snapshot reference into the document database 312.

At block 612, the certification system 304 provides a prompt to the SME device 110 indicating that the new version needs certification. For example, based on a request and/or periodically, the certification system 304 may seek authentication of uncertified document snapshot references 316, including the uncertified document snapshot reference that was generated and stored in block 610. To perform the certification, the certification system 304 may provide a prompt to the SME device 110.

At block 614, the SME device 110 may query document versions from the document repository 604. For example, the SME device 110 may provide a request directly to the document repository 604 to request all versions of the first document that is stored within the document repository. In some instances, the SME device 110 may provide the request to the certification system 304, and the certification system 304 may facilitate the retrieval of the versions of the first document.

Referring to FIG. 6B, at block 616, the document repository 604 provides a list of document versions of the first document to the SME device 110. For example, based on the query from block 614, the document repository 604 may search for versions of the first document (e.g., all versions of the first document), and provide the list to the SME device 110.

At block 618, the SME device 110 identifies a version fit for certification. For example, the SME 108, using the SME device 110, may review one or more versions of the first document from the document repository 604, and provide input identifying that a version is ready for certification.

At block 620, the SME device 110 identifies certification time boundaries, and obtain input from the SME 108 indicating the certification time boundaries. Additionally, and/or alternatively, the SME device 110 may obtain input from the SME 108 indicating additional metadata. For example, referring to FIG. 3B, one or more fields may be from the SME device 110 at block 620. For instance, the SME 108, using the SME device 110, may provide input indicating the person certifying the document (e.g., field 336), the date of certification (e.g., field 338), and the duration of certification (e.g., fields 340-342). Additionally, and/or alternatively, the SME 108, using the SME device 110, may provide additional input such as notes (e.g., field 344).

At block 622, the SME device 110 certifies the designated document version for a specific time (e.g., indicated based on block 620), and provides the certification to the document database 312 (e.g., a certification indication from the SME 108 that is provided by the SME device 110 to the federated KB computing platform 112). For example, based on the input from the SME 108, the SME device 110 may update the snapshot reference within the document database 312. For instance, as mentioned above, after the author authored the new version of the first document, an uncertified document snapshot reference may be stored within the document database 312. Here, based on the certification information from the SME device 110 indicating the certification, the federated KB computing platform 112 may generate (e.g., update and/or modify) a certified document snapshot reference for the new version of the first document. For instance, based on the certification information the federated KB computing platform 112 may update the uncertified document snapshot reference for the new version of the first document such that this snapshot reference becomes a certified document snapshot reference. Furthermore, the federated KB computing platform 112 may include additional certification information from the SME 108 into the certified document snapshot reference. For instance, the federated KB computing platform 112 may include the input from the SME 108 such as the person certifying the document (e.g., field 336), the date of certification (e.g., field 338), the duration of certification (e.g., fields 340-342), and/or additional input such as notes (e.g., field 344).

At block 624, the document database 312 stores the certified document snapshot reference into the document database 312. For instance, based on the certification information and/or the updates/modifications, the federated KB computing platform 112 may obtain a certified document snapshot reference such as the snapshot reference 320 shown in FIG. 3B, which includes the fields 336-334 from the SME 108, the identifiers 328-330, and other information. Then, the federated KB computing platform 112 may store the certified document snapshot reference into the document database 312. Following, process 400 may be used to retrieve the certified document snapshot reference, and then use the certified document snapshot reference.

In other words, referring to event sequence 600, the author, the federated KB computing platform 112, and the SME 108 may perform certain steps.

For example, at blocks 606 and 608, the author may author a project such as a tax calculator service, and then author the first document. The first document may be an API md file, the type of the document repository 604 may be GITHUB Enterprises, and the name of the document repository 604 may be a tax repository. In some instances, to register the document with the document repository 604 (e.g., a KB computing system 114), the author device 602 may provide data such as the title, uncertified identifier, keywords, vectors, and/or notes. For instance, the additional data may include the title (e.g., the title shown in FIG. 3B in field 326), the uncertified identifier (e.g., the identifier shown in FIG. 3B in field 328), the keywords and vectors (e.g., the keywords and vectors shown in FIG. 3B in fields 332 and 334), and a note such as “This is an uncertified document API. md.” The author may further maintain the project version history for the document repository 604, and determine whether the project has reached a release phase. Based on the project reaching the release phase, the author may change the note to “Release v1,” and request the certification.

The document repository 604 may be a KB computing system 114 that records, tracks, and maintains both certified and uncertified document snapshot references, along with a variety of data helpful towards discovery, such as keywords (for traditional keyword search) and document vectors (for AI search). Additionally, and/or alternatively, the document repository 604 may track the governance time period, and mark the document as “expired” when the certification period runs out. The document repository 604 may also provide other document flags such as “obsolete” or “superseded.”

The document repository 604 and the federated KB computing platform 112 may work together to perform federated knowledge governance. For instance, based on the information from the author, at block 608 and 610, the federated KB computing platform 112 may generate and store an uncertified document snapshot reference for the first document (e.g., the tax calculator service snapshot reference). Then, based on the author determining that the project has reached a release phase and tagging the appropriate commit, at block 612, the federated KB computing platform 112 may perform block 612 and provide a prompt indicating that this new version needs certification. For example, the author device 602 may provide a request to the document repository 604 indicating that the project has reached a release phase and the new version of the first document is ready for certification (e.g., the version “4f5e68” of the first document). The document repository 604 may provide the request to the federated KB computing platform 112, and the federated KB computing platform 112 may perform block 612.

Following, the federated KB computing platform 112 and the SME device 110 may work together to perform the certification. For instance, after receiving the certification request, the SME device 110 may perform block 612 to retrieve a list of document versions, and perform blocks 618-622 to provide the certification information.

After, if valid, the SME device 110 may indicate that the document version in the document repository 604 (e.g., the document version “4f5e68”) is valid. The SME device 110 may provide the indication to the document repository 604 and/or the federated KB computing platform 112. Afterwards, the uncertified document snapshot reference associated with the document version may be updated such as by including fields 330 and 332-344 as described above.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A system, comprising:
a consumer device that is configured to provide a search request for a certified version of a first document that is stored in a first knowledge base (KB) computing system;
a federated KB computing platform configured to:
receive the search request from the consumer device;
based on the search request, determine a first document snapshot reference that comprises an identifier that identifies a storage location of the certified version of the first document within the first KB computing system, wherein the federated KB computing platform stores a plurality of document snapshot references associated with a plurality of documents that are stored in a plurality of different KB computing systems, and wherein the first KB computing system stores a plurality of versions of the first document including a latest version of the first document and the certified version of the first document;
based on the determination, retrieve the identifier that identifies the storage location of the certified version of the first document within the first KB computing system;
based on providing the identifier to the first KB computing system, obtain the certified version of the first document from the first KB computing system;
generate a user interface (UI) based on the retrieved certified version of the first document; and
cause display of the UI on the consumer device, wherein the consumer device is configured to display the UI comprising the retrieved certified version of the first document; and
the first KB computing system configured to:
receive the identifier from the federated KB computing platform;
retrieve the certified version of the first document using the identifier; and
provide the certified version of the first document to the federated KB computing platform.

2. The system of claim 1, wherein each of the plurality of document snapshot references that is stored in the federated KB computing platform comprises one or more keywords associated with the plurality of documents, and wherein determining the first document snapshot reference comprises:
performing a keyword search based on the search request and the one or more keywords within the plurality of document snapshot references to determine the first document snapshot reference.

3. The system of claim 1, wherein each of the plurality of document snapshot references that is stored in the federated KB computing platform comprises one or more vectors associated with the plurality of documents, and wherein determining the first document snapshot reference comprises:
performing a generative artificial intelligence (AI) search based on the search request and the one or more vectors within the plurality of document snapshot references to determine the first document snapshot reference.

4. The system of claim 1, wherein the federated KB computing platform is further configured to:
receive, from the first KB computing system, a registration request for a new version of the first document;
generate an uncertified document snapshot reference for the new version of the first document, wherein the uncertified document snapshot reference comprises a first identifier that indicates a storage location of the uncertified version of the first document within the first KB computing system; and
store the uncertified document snapshot reference within a document database of the federated KB computing platform.

5. The system of claim 4, wherein the federated KB computing platform is further configured to:
subsequent to storing the uncertified document snapshot reference, provide a prompt to a subject matter expert (SME) device requesting certification for the first document;
receive, from the SME device, a certification indication indicating that the new version of the first document is certified; and
generate the first document snapshot reference comprising the identifier based on the certification indication from the SME device, wherein the new version of the first document becomes the certified version of the first document based on the certification indication.

6. A method, comprising:
receiving, from a consumer device and by a federated knowledge base (KB) computing platform, a search request for a certified version of a first document that is stored in a first KB computing system;
based on the search request, determining, by the federated KB computing platform, a first document snapshot reference that comprises an identifier that identifies a storage location of the certified version of the first document within the first KB computing system, wherein the federated KB computing platform stores a plurality of document snapshot references associated with a plurality of documents that are stored in a plurality of different KB computing systems, and wherein the first KB computing system stores one or more versions of the first document including the certified version of the first document;
retrieving, by the federated KB computing platform and based on the determination, the identifier that identifies the storage location of the certified version of the first document within the first KB computing system; and
using the identifier to access the certified version of the first document that is stored in the first KB computing system.

7. The method of claim 6, wherein each of the plurality of document snapshot references that is stored in the federated KB computing platform comprises one or more keywords associated with the plurality of documents, and wherein determining the first document snapshot reference comprises:
performing a keyword search based on the search request and the one or more keywords within the plurality of document snapshot references to determine the first document snapshot reference.

8. The method of claim 6, wherein each of the plurality of document snapshot references that is stored in the federated KB computing platform comprises one or more vectors associated with the plurality of documents, and wherein determining the first document snapshot reference comprises:
performing a generative artificial intelligence (AI) search based on the search request and the one or more vectors within the plurality of document snapshot references to determine the first document snapshot reference.

9. The method of claim 6, wherein the identifier is a deep link, and wherein using the identifier to access the certified version of the first document that is stored in the first KB computing system comprises using the deep link to access the certified version of the first document.

10. The method of claim 6, wherein using the identifier to access the certified version of the first document that is stored in the first KB computing system comprises:
providing, by the federated KB computing platform, the identifier to the consumer device; and
accessing, by the consumer device, the certified version of the first document that is stored in the first KB computing system using the provided identifier.

11. The method of claim 6, wherein using the identifier to access the certified version of the first document that is stored in the first KB computing system comprises:
retrieving, by the federated KB computing platform and using the identifier, the certified version of the first document from the first KB computing system;
generating, by the federated KB computing platform, a user interface (UI) for the certified version of the first document, wherein the UI comprises one or more features and the certified version of the first document; and
causing display of the UI on the consumer device.

12. The method of claim 6, further comprising:
receiving, by the federated KB computing platform and from the first KB computing system, a registration request for a new version of the first document;
generating, by the federated KB computing platform, an uncertified document snapshot reference for the new version of the first document, wherein the uncertified document snapshot reference comprises a first identifier that indicates a storage location of the uncertified version of the first document within the first KB computing system; and
storing, by the federated KB computing platform, the uncertified document snapshot reference within a document database of the federated KB computing platform.

13. The method of claim 12, further comprising:
receiving, from an author device, author information associated with the new version of the first document, wherein the author information comprises a title, the first identifier, one or more keys, and one or more vectors associated with the new version of the first document, and
wherein generating the uncertified document snapshot reference is based on the author information.

14. The method of claim 12, further comprising:
subsequent to storing the uncertified document snapshot reference, providing, by the federated KB computing platform, a prompt to a subject matter expert (SME) device requesting certification for the first document;
receiving, from the SME device and by the federated KB computing platform, a certification indication indicating that the new version of the first document is certified; and
generating the first document snapshot reference comprising the identifier based on the certification indication from the SME device, wherein the new version of the first document becomes the certified version of the first document based on the certification indication.

15. The method of claim 14, further comprising:
based on the prompt, obtaining, by the SME device, a list of document versions for the first document, wherein the list of document versions comprises a previously certified version of the first document and the new version of the first document;
receiving, by the SME device, input from an SME comprising certification indication for the new version of the first document; and
providing, by the SME device, the certification indication to the federated KB computing platform.

16. The method of claim 15, wherein the input from the SME further comprises certification information indicating a name of the SME, a date of the certification indication, and certification time boundaries, and wherein generating the first document snapshot reference comprises:
updating the uncertified document snapshot reference within the document database based on the certification information to generate the first document snapshot reference; and
storing the first document snapshot reference in the document database.

17. The method of claim 6, wherein the first KB computing system stores a plurality of versions of the first document, wherein the plurality of versions of the first document comprises the certified version of the first document and a latest version of the first document, wherein the certified version of the first document is different from the latest version of the first document.

18. The method of claim 6, wherein the first KB computing system stores a plurality of versions of the first document, wherein the plurality of versions of the first document comprises the certified version of the first document that is also a latest version of the first document.

19. The method of claim 6, wherein the method further comprises:
prior to determining the first document snapshot reference, receiving, from a subject matter expert (SME) device, a certification indication indicating to certify a version of the first document that is not a latest version of the first document; and
generating the first document snapshot reference comprising the identifier based on the certification indication from the SME device, wherein the version of the first document becomes the certified version of the first document based on the certification indication.

20. A non-transitory computer-readable medium having processor-executable instructions stored thereon, wherein the processor-executable instructions, when executed, facilitate:
receiving, from a consumer device, a search request for a certified version of a first document that is stored in a first knowledge base (KB) computing system;
based on the search request, determining a first document snapshot reference that comprises an identifier that identifies a storage location of the certified version of the first document within the first KB computing system, wherein a federated KB computing platform stores a plurality of document snapshot references associated with a plurality of documents that are stored in a plurality of different KB computing systems, and wherein the first KB computing system stores one or more versions of the first document including the certified version of the first document;
retrieving, based on the determination, the identifier that identifies the storage location of the certified version of the first document within the first KB computing system; and
using the identifier to access the certified version of the first document that is stored in the first KB computing system.
